(19) United States
(12) Patent Application Publication
(10) Pub. No.: US 2026/0292860 A1
(43) Pub. Date: Sep. 24, 2026

(54) SYSTEMS AND METHODS FOR INTERFERENCE MITIGATION

(71) Applicant: T-Mobile Innovations LLC, Overland Park, KS (US)

(72) Inventors: Krunal MODASIYA, Aldie, VA (US); Mohd Khalil ABU BAKAR, Herndon, VA (US); Hirensinh R. RANA, Olathe, KS (US); Samuel D. WYMAN, III, Arlington, VA (US)

(21) Appl. No.: 19/084,911

(22) Filed: Mar. 20, 2025

(51) Int. Cl. H04W 72/541; H04W 56/00; H04W 72/27; H04W 92/20

(52) U.S. Cl. CPC H04W 72/541; H04W 56/004; H04W 72/27; H04W 92/20

(57) ABSTRACT

Systems, methods and devices are provided for network congestion management. The method includes determining an area of overlapping coverage of a first network node and a second network node based on an angle of arrival (AoA) for the first network node and an AoA for the second network node, determining a first set of physical resource blocks (PRBs) for the first network node and a second set of PRBs for the second network node for the area of overlapping coverage and assigning a physical resource block (PRB) grouping to the first set of PRB that is different from a PRB grouping of the second set of PRB.

### TECHNICAL BACKGROUND

Devices connected to the outer boundary of a coverage area of a network node, such as LTE or new radio 5G (NR 5G) network nodes, may experience a degraded connection quality due to high interference from other overlapping network nodes. Often, interference between devices connected to overlapping network nodes may contribute to the high interference. For example, two devices connected to overlapping network nodes may interference with each other’s connectivity due to the two devices transmitting and receiving on the same or adjacent frequency resources.

### OVERVIEW

Exemplary embodiments described herein include systems, methods, and processing nodes for interference mitigation. An exemplary method includes determining an area of overlapping coverage of a first network node and a second network node based on an angle of arrival (AoA) for the first network node and an AoA for the second network node, determining a first set of physical resource block (PRBs) for the first network node and a second set of PRBs for the second network node for the area of overlapping coverage and assigning a physical resource block (PRB) grouping to the first set of PRB that is different from a PRB grouping of the second set of PRB.

Further exemplary embodiments include a system for interference mitigation. The system includes a wireless network comprising a first network node, a second network node and a computing device communicatively connected to the first and the second network nodes, the computing device configured to determine an area of overlapping coverage of the first network node and the second network node based on an AoA for the first network node and an AoA for the second network node, determine a first set of PRBs for the first network node and a second set of PRBs for the second network node for the area of overlapping coverage and assign a PRB grouping to the first set of PRB that is different from a PRB grouping of the second set of PRB.

In yet a further exemplary embodiment, a non-transitory computer readable medium is provided. The non-transitory computer-readable medium stores instructions, when executed by a processor, configuring the processor to determine an area of overlapping coverage of a first network node and a second network node based on an AoA for the first network node and an AoA for the second network node, determine a first set of PRBs for the first network node and a second set of PRBs for the second network node for the area of overlapping coverage and assign a PRB grouping to the first set of PRB that is different from a PRB grouping of the second set of PRB.

### BRIEF DESCRIPTION OF THE DRAWINGS

These and other more detailed and specific features of various embodiments are more fully disclosed in the following description, reference being had to the accompanying drawings, in which:

FIG. 1 illustrates an exemplary system for wireless communication in accordance with various aspects of the present disclosure;

FIG. 2 illustrates a diagram with an example of interference mitigation in accordance with disclosed embodiments;

FIG. 3 illustrates an exemplary process flow for interference mitigation in accordance with aspects of this disclosure;

FIG. 4 illustrates an example of a computing device in accordance with aspects of this disclosure; and

FIG. 5 illustrates an exemplary processing node in accordance with various aspects of the present disclosure.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In accordance with various aspects of the present disclosure, network nodes provide interference mitigation based on angle of arrival (AoA) of wireless devices.

Networks such as LTE and NR 5G allocate physical resource blocks (PRBs) to provide network resources a connecting device.

As a device connects to the network, the AoA of the device may influence the carrier-to-interference-plus-noise ratio (CINR) for the connection. For example, a device with a short and direct path to a network node (base station) serving the device may have a connection with a higher CINR than a device connecting at the edges of coverage for that network node.

Often a network node may compensate for this decrease in CINR by allocating more PRB to the connection. One issue this method may create is an increased interference between devices with similar or same PRB allocations by separate network nodes when the devices are connected at the edge of coverage areas for the base stations (i.e. connection handover area).

Current methods of dynamic allocation of PRB for limiting this interference often degrade the service to one or more devices as some devices are prioritized for allocation over other devices.

Two network nodes of a wireless network may be able to mitigate this interference by allocating ranges of PRB to devices connected at the edge of coverage of the base stations that do not overlap. This may be accomplished by allocating ranges or groupings of PRB based on AoA for the devices. For example, the PRBs allocated to a device connected to a first network node at a range of AoA would have a PRB with a minimum probability of overlapping with the PRB allocated to another device connected to a second network node at the same range of AoA.

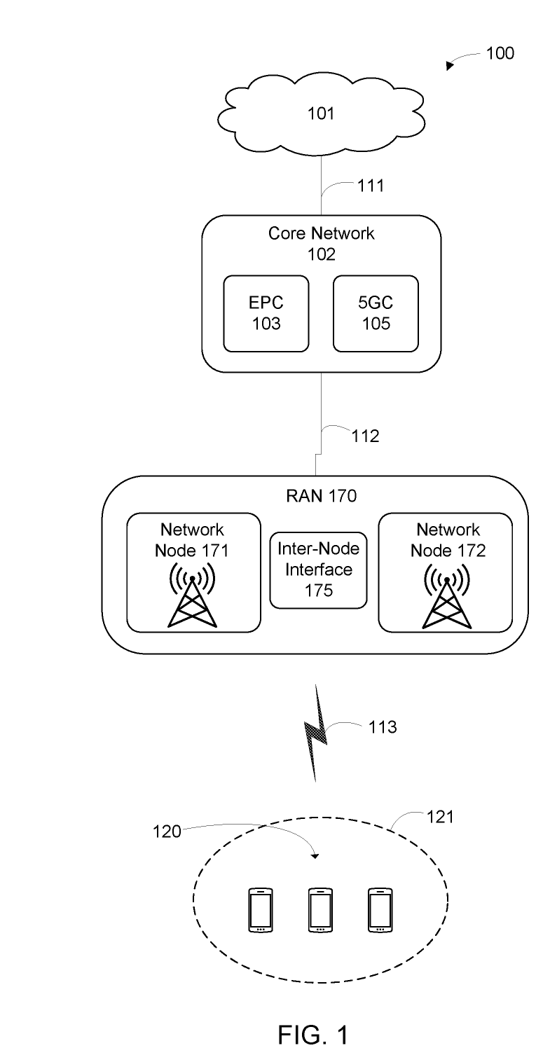

These and other examples will be described in greater detail below in relation to FIGS. 1-5.

FIG. 1 depicts an exemplary system 100 for deactivation of inactive subscription. System 100 includes a communication network 101, a core network 102, a radio access network (RAN) 170 and wireless devices 120.

Core network 102 is connected to communication network 101 over communication link 111. Core network 102 includes an evolved packet core (EPC) 103. EPC 103 as used herein are core network components used for managing data for LTE, 4G, and/or other networks. In embodiments, EPC 103 includes a mobility management entity (MME) and a packet data network gateway (PGW). MME is responsible for handling connection and mobility management tasks on an LTE/4G network. PGW is responsible for session continuity on connection handover on an LTE/4G network. For example, the MME may receive a connection handover request based on poor signal for the connection and the PGW ensures session continuity during the transition between base stations.

Core network 102 includes a 5G core (5GC) 105. 5GC 105 as used herein are core network components used for managing data for 5G networks. In embodiments, 5GC 105 includes an access and mobility function (AMF) and a session management function (SMF). AMF receives connection and session related information from a user device and is responsible for handling connection, registration and mobility management tasks on a 5G network. The SMF handles session transfer during a handover. For example, the AMF may receive a handover request based on signal degradation, once AMF identifies a target base station for handover of the connection, SMF ensures the continuity of the session through the transition.

It should be noted that core network 102 may include other components used for managing data for networks not described herein and may have other types of core architecture (e.g., 6G core architecture) that at least perform some similar functions as and/or share at least some components with EPC 103 and 5GC 105 with respect to connection and connection handover. For example, embodiments described herein may utilize an artificial intelligence (AI) enhanced access and mobility management function (AMF) of a 6G network.

The RAN 170 includes network nodes 171 and 172. In embodiments, the network nodes 171/172 include an evolved Node B (eNodeB) and a next generation Node B (gNodeB). As used herein, an eNode B is a base station in LTE/4G networks used for connecting a user device, such as wireless device 120, to core network 102. A gNodeB, as used herein, is a base station in new radio 5G networks and/or other networks used for connecting a user device to core network 102. The gNodeB may include, for example, centralized units (CUs) and distributed units (DUs).

The RAN 170 may determine AoA of wireless devices 120. In instances, RAN 170 may determine AoA of a wireless device pre-attachment. In embodiments, RAN 170 may determine AoA of a wireless device post-attachment. RAN 170 may determine an AoA using time difference of arrival (TDOA), phase difference of arrival (PDOA), and the like.

The RAN 170 also includes an inter-node interface 175. Inter-node interface 175, as used herein, is a logical interface that enables direct communication between network nodes. For example, the inter-node interface 175 may be used for coordinating PRB allocation between network node 171 and network node 172. In embodiments, inter-node interface 175 may include a X2 interface for communication between eNnodeB network nodes 171/172. X2 interface may enable handover, interference coordination and load balance between two eNodeB network nodes 171/172. In embodiments, if inter-node interface 175 is unavailable, EPC 103 may be used for handling a connection handover.

In instances, inter-node interface 175 may be a Xn interface for communication between gNodeB network nodes 171/172. Similar to described above, Xn interface may enable handover, load balance and interference coordination between gNodeb network nodes 171/172. In embodiments, if the Xn interface is unavailable, 5GC 105 may be used for managing the connection handover. It should be noted that inter-node interface 175 is described in relation to network nodes 171/172 for ease of description and it should not be read as limited to only the two network nodes 171/172.

RAN 170 is connected to core network 102 over communication link 112. RAN 170 may include other devices and additional nodes not described herein. For example, RAN 170 may include devices used for forwarding media files over IP from wireless devices 120 to core network 102.

System 100 also includes wireless devices 120. In embodiments, system 100 may include two or more wireless devices. Wireless devices 120 are configured to operate in one or more coverage areas 121. Wireless devices 120 may include an end-user wireless device. Wireless devices 120 may include any device configured to send and receive data. In instances, wireless devices 120 may include any wireless device capable of providing signals used for angle of arrival (AoA) estimation. For example, wireless device 120 may include a device capable of transmitting sounding reference signals (SRS) to RAN 170. In embodiments, wireless device 120 communicates with RAN 170 over communication link 113. Examples of communication link 113 may include 6G network, 5G network, 4G LTE, and the like.

Communication network 101 may be a wired and/or wireless communication network. In embodiments, communication network 101 may include processing nodes, routers, gateways, physical and/or wireless data links for carrying data among various network elements, including combinations thereof. In embodiments, communication network 101 may include a local area network, a wide area network, an inter-network, such as the internet, and the like. Communication network 101 may be capable of carrying data, such as, for example, to support multimedia files, and data communications by wireless devices 120. Wireless network protocols can include multimedia broadcast multicast service (MBMS), code division multiple access (CDMA) 1xRTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), Fifth Generation mobile networks or wireless systems (5G, 5G New Radio (“5G NR”), or 5G LTE), and Sixth Generation mobile networks (6G or 6G next generation (“6G NG”)) and/or non-terrestrial networks. Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), Asynchronous Transfer Mode (ATM), and/or so forth. Communication network 101 may also include additional base stations, controller nodes, telephony switches, internet routers, network gateways, computer systems, communication links, or some other type of communication equipment, and combinations thereof.

The core network 102 includes core network functions and elements. The core network 102 may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, such as network 101, and performs operations such as packet routing and forwarding, packet inspection, policy enforcement for the user plane, quality of service (QoS) handling, etc. The control plane functions may include, for example, a network slice selection function (NSSF), a network exposure function (NEF), a network repository function (NRF), a policy control function (PCF), a unified data management (UDM), an application function (AF), an AMF, such as AMF, an authentication server function (AUSF) and SMF. Additional or fewer control plane functions may also be included. The AMF receives connection and session related information from the wireless devices 120 and is responsible for handling connection and mobility management tasks. The SMF is primarily responsible for creating, updating, and removing sessions and managing session context. The UDM function provides services to other core functions, such as the AMF, SMF, and NEF. The UDM may function as a stateful message store, holding information in local memory. The NSSF can be used by AMF to assist with the selection of network slice instances that will serve a particular device. Further, the NEF provides a mechanism for securely exposing services and features of the core network.

Although one core network 102 is shown, multiple core networks 102 may be utilized. Alternatively, the single core network 102 may include a distributed, cloud-native, converged core gateway. Thus, the converged core gateway could connect an EPC 103 to5GC 105 network.

Communication links 111 and 112 can use various communication media, such as air, space, metal, optical fiber, or some other signal propagation path, including combinations thereof. Communication links 111 and 112 can be wired or wireless and use various communication protocols such as Internet, Internet protocol (IP), local-area network (LAN), S1, optical networking, hybrid fiber coax (HFC), telephony, T1, or some other communication format - including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, 6G or combinations thereof. Other wireless protocols can also be used. Communication links 111 and 112 can be direct links or might include various equipment, intermediate components, systems, and networks, such as a cell site router, etc. Communication links 111 and 112 may comprise many different signals sharing the same link.

In embodiments, RAN 170 may include various access network systems and devices such as network nodes 171 and 172. The RAN 170 is disposed between the core network 102 and the end-user wireless device 120. Components of the RAN 170 may communicate directly with the core network 102 and others may communicate directly with the end user wireless device 120. The RAN 170 may provide services from the core network 102 to the end-user wireless device 120. The RAN 170 may provide connection handover between network node 171 and network node 172 through inter-node interface 175. In instances, the RAN 170 may provide connection handover between network node 171 and network node 172 through core network 102. It is understood that the disclosed technology may also be applied to communication between an end-user wireless device and other network resources, such as relay nodes, controller nodes, antennas, etc. Further, multiple network nodes may be utilized. For example, some wireless devices may communicate with an eNodeB and others may communicate with a gNodeB. It should be noted that only two network nodes 171 and 172 are shown in FIG. 1 for illustrative purposes and, as such, RAN 170 may include a plurality of network nodes not shown in the figure.

In additional embodiments, network nodes 171/172 may comprise two co-located cells, or antenna/transceiver combinations that are mounted on the same structure. Alternatively, network nodes 171/172 may comprise a short range, low power, small-cell network node such as a microcell network node, a picocell network node, a femtocell network node, and/or a home eNodeB device. As will be further described below, functionality for network node switching may be included within the network nodes 171/172.Network nodes 171/172 can be configured to deploy one or more different carriers, utilizing one or more RATs. For example, a gNodeB may support NR. It would be evident to one of ordinary skill in the art, in light of this disclosure, the many other combinations of network nodes and carriers that could be deployed.

The network nodes 171/172 may include processors and associated circuitry to execute or direct the execution of computer-readable instructions to perform operations such as those further described herein. Network nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The wireless devices 120 may include any wireless device included in a wireless network. For example, the term “wireless device” may include a relay node, which may communicate with a network node. The term “wireless device” may also include an end-user wireless device, which may communicate with network nodes 171 through the relay node. The term “wireless device” may further include an end-user wireless device that communicates with the network node 171 directly without being relayed by a relay node.

Wireless devices 120 may be any device, system, combination of devices, or other such communication platform capable of communicating wirelessly with network nodes 171/172 using one or more frequency bands and wireless carriers deployed therefrom. Each of wireless devices 120, may be, for example, a mobile phone, a wireless phone, a wireless modem, a personal digital assistant (PDA), a voice over internet protocol (VoIP) phone, a voice over packet (VOP) phone, or a soft phone, an internet of things (IoT) device, as well as other types of devices or systems that can send and receive audio or data. The wireless device 120 may be or include high power wireless devices or standard power wireless devices. Other types of communication platforms are possible.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork, such as the internet. System 100 may be capable of communicating signals and carrying data, for example, to support voice, push-to-talk, broadcast video, and data communications by end-user wireless devices 120. System 100 may include additional base stations, controller nodes, telephony switches, internet routers, network gateways, computer systems, communication links, or other type of communication equipment, and combinations thereof.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between the RAN 170 and the core network 102.

The methods, systems, devices, networks, network nodes, and equipment described herein may be implemented with, contain, or be executed by one or more computer systems and/or processing nodes. The methods described above may also be stored on a non-transitory computer readable medium. Many of the elements of system 100 may be, comprise, or include computers systems and/or processing nodes, including network nodes, controller nodes, and gateway nodes described herein.

The operations for network node switching may be implemented as computer-readable instructions or methods, and processing nodes on the network and/or computing device, such as end user wireless device, for executing the instructions or methods. The processing node may include a processor included in the network node or a processor included in any controller node in the wireless network that is coupled to the network node. The computing device may include at least a processor and a memory with instructions configuring the processor to execute instructions.

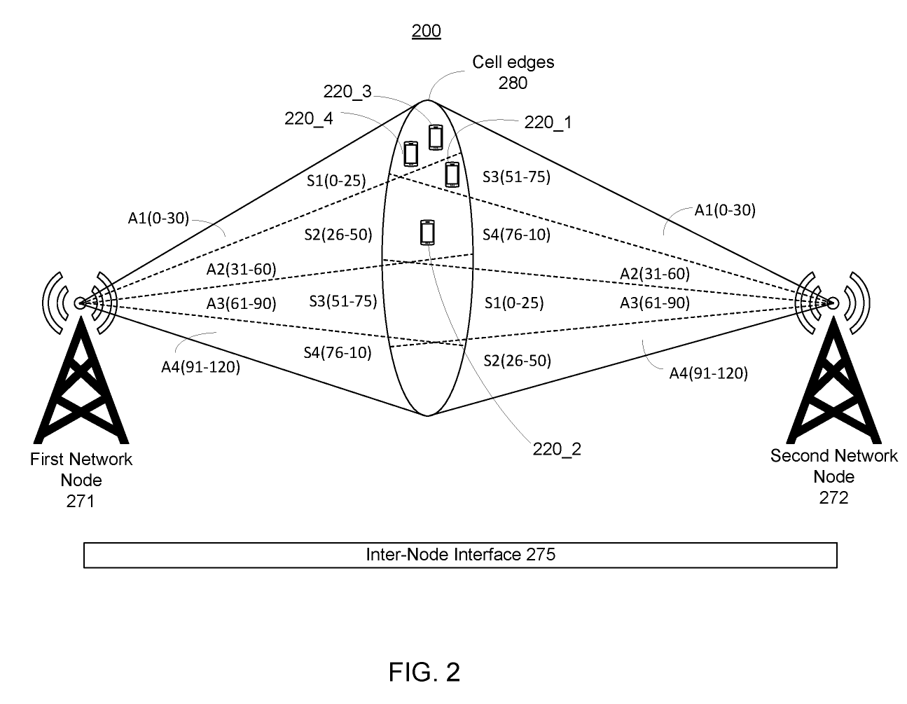

Now referring to FIG. 2, an example diagram 200 of interference mitigation is illustrated. This example includes a first network node 271, a second network node 272 and an inter-node interface 275. In embodiments, the first network node 271, the second network node 272 and the inter-node interface 275 may be the same as network node 171, network node 172 and inter-node interface 175.

This example also includes wireless devices 220_1, 220_2, 220_3 and 220_4, which are examples of wireless device 120. In this example, the PRB allocated to wireless devices 220 by first network node 271 and second network node 272 are divided into four separate angular coverage segments, which are shown as A1, A2, A3 and A4. Each angular coverage segment includes a range of a total angle of coverage (i.e. an AoA range). The PRB allocation is divided into groupings S1, S2, S3 and S4.

For ease of description, the example diagram will be described with a total angle of coverage of 120 degrees and a PRB allocation range of 0-100. However, it should be noted that that other examples may include different angles and PRB allocation than the example described. Furthermore, the angular coverage segments and the PRB allocation may be divided into more or less than the four separate parts shown in this example.

In this example, A1 corresponds to AoAs ranging from 0-30, A2 corresponds to AoAs ranging from 31-60, A3 corresponds to AoAs ranging from 61-90 and A4 corresponds to AoAs ranging from 91-120. As mentioned above, the AoA ranges and distributions are provided as an example and other examples may include different ranges of AoA distributions and/or total angle for AoAs.

This example also includes a PRB grouping or grouping S1 that corresponds to a range of 0-25 PRB numbers, PRB grouping S2 corresponds to a range of 26-50, PRB grouping S3 corresponds to a range of 51-75 and PRB grouping S4 corresponds to a range of 76-100.

The example 200 also includes cell edges 280. The cell edges, as used herein, are the overlapping outer boundaries of coverage of both first network node 271 and second network node 272. For example, the cell edges 280 is the boundary of coverage where the signal starts to degrade. In some instances, the cell edges 280 may enable a connection handover to be triggered. For example, a device connected to first network node 271 may connect to the second network node 272 if the signal of the connected node continues to degrade while the signal of the second node continues to improve.

In this example, the inter-node interface 275, which may include an X2 interface or an Xn interface, depending on the type of network nodes 271/272 involved in the connection handover (e.g. eNodeB and gNodeB). Inter-node interface 275 may include, or be the same as, inter-node interface 175. Inter-node 275 communicates the assigned PRB groupings for AoAs and overlapping coverage between network nodes in the network to prevent assigning the same PRB groupings for an overlapping coverage area of neighboring nodes to minimize overlap of PRB groupings and minimizing interference. For example, in the overlapping coverage areas for first network node 271 and second network node 272 have different assigned PRB groupings.

Continuing on example 200, wireless device 220_3 is shown as being served, while located at the cell edge 280, by second network node 272 with an assigned angular coverage segment of A1 and a PRB grouping of S3 while wireless device 220_4 is shown as being served, while located at the cell edge 280, by first network node 271 with an assigned angular coverage segment of A1 and a PRB grouping of S1. Although wireless device 220_3 and wireless device 220_4 have the same assigned angular coverage segment A1, as they are assigned different PRB groupings (S3 corresponding to a range of 0-25 PRB numbers and S1 corresponding to a range of 51-75, respectively) interference for both devices is greatly minimized since the PRB groupings do not overlap.

In the handover context, wireless device 220_1 is shown as being served, while located at the cell edge 280, by second network node 272 with an assigned angular coverage segment of A1 and a PRB grouping of S3. If a connection handover is triggered, the wireless device 220_1 will start being served by second network node 271, in which case the AoA for the first network node will become A2 with a PRB grouping of S2. The device changes from a PRB grouping of a range 51-75 to a range of 26-50. As shown in this example, even if the angular coverage segment for the device changes, the PRB grouping allocated to the device does not overlap with other devices being served at that AoA range by another node at the same angular coverage segment. For example, as mentioned above, the wireless device 220_1 would be allocated a PRB grouping of S2 (range of 26-50) at the A2 AoA range. In this example, if a wireless device, shown as wireless device 220_2, is being served by second network node 272 at AoA A2, wireless device 220_2 would have a PRB grouping of S4 (range of 76-100), while the wireless device 220_1 being served by first network node 271 would have a PRB grouping of S2 (range of 26-50). Thus, the interference between wireless device 220_1 and 220_2 caused by the same PRB being assigned to both devices is greatly minimized since the PRB groupings do not overlap.

In this example, wireless device 220_3 is shown as being served by first network node 271 at AoA A1. Because the PRB groupings for first network node 271 and the second network node 272 do not overlap, even if the wireless device 220_1 changes the angular coverage segment, such as due to movement of the device, the interference by the wireless device 220_3 with the wireless device 220_1, and vice versa, is minimized as the allocated PRB for wireless device 220_3 does not overlap with PRB allocation for wireless device 220_1. As such, the probability of the first network node 271 allocating the same PRB to wireless device 220_3 as the PRB assigned by second network node 272 is minimized. As shown in this example, interference between devices connected to different network nodes sharing the same angular coverage segment is reduced because the first and second network nodes 271/272 coordinate allocation of PRBs as to prevent the same PRB from being allocated to separate devices at the cell edges 280.

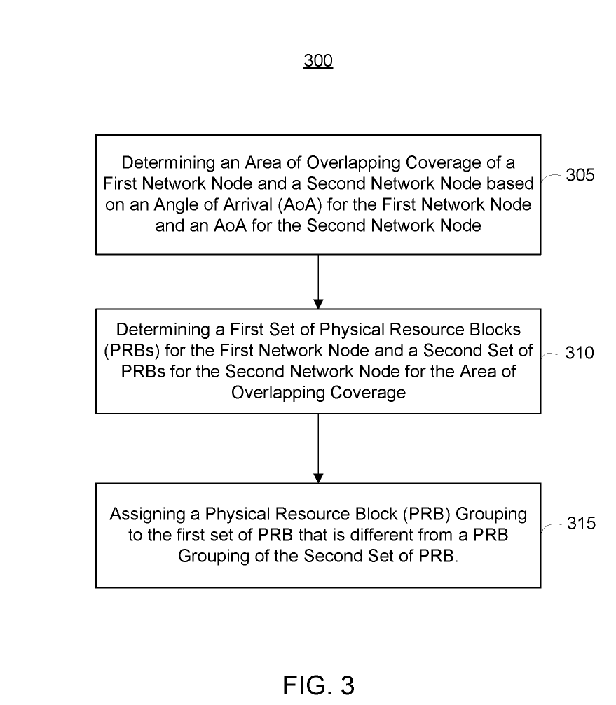

With reference to FIG. 3, a flow diagram of method 300 for interference mitigation is presented. Method 300 includes, at step 305, determining an area of overlapping coverage of a first network node and a second network node based on an AoA for the first network node and an AoA for the second network node. In embodiments, the AoA for the first network node and the AoA for the second network node are the same AoA for the area of overlapping coverage. The first and second network nodes may be the same as first and second network nodes 271/272, respectively.

The method 300, at step 310, includes determining a first set of PRBs for the first network node and a second set of PRBs for the second network node for the area of overlapping coverage.

At step 315, method 300 includes assigning a PRB grouping to the first set of PRBs that is different from a PRB grouping of the second set of PRB. In instances, assigning the PRB grouping to the first set of PRBs and the PRB grouping to the second set of PRBs comprises using an inter-node interface. The inter-node interface may include inter-node interfaces 175/275 described in reference to FIGS. 1 and 2, respectively.

The method 300 may include determining angular coverage segments for the first network node and the second network node based on an AoA range of the first and second network node, wherein each angular coverage segment of the angular coverage segments comprises a subrange of the AoA range. In embodiments, the method 300 may include assigning the same AoA subrange to an angular coverage segment of the first network node and to an angular coverage segment of the second network node for the area overlapping coverage.

In some embodiments, methods 300 may include additional steps or operations. Furthermore, the methods may include steps shown in each of the other methods. As one of ordinary skill in the art would understand, method 300 may be integrated in any useful manner and the steps may be performed in any useful sequence.

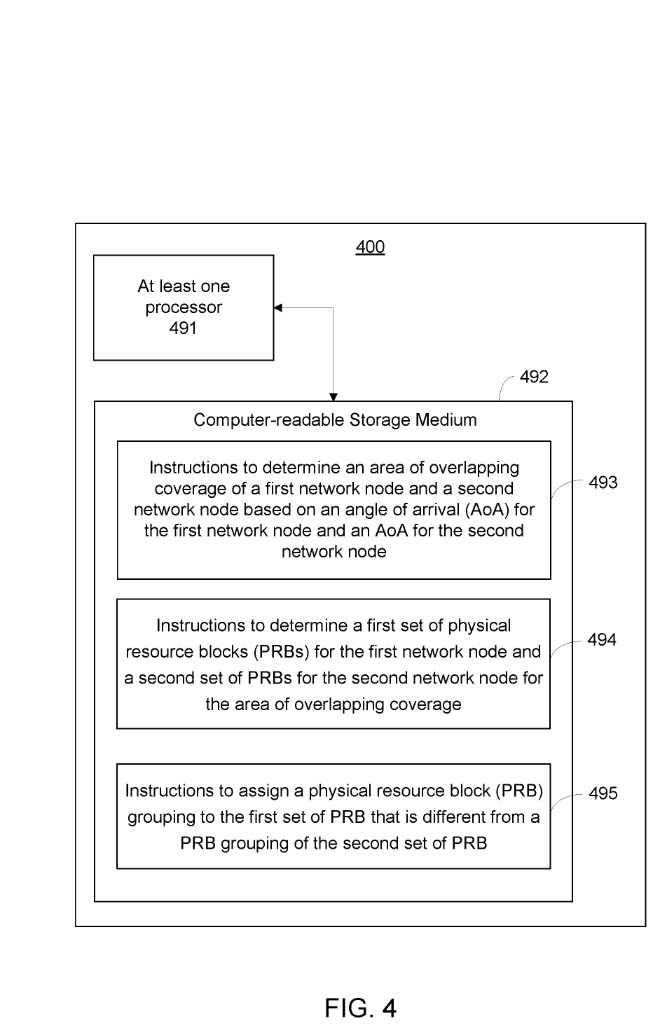

Now referring to FIG. 4, an example computing device 400 is presented. In embodiments, computing device 400 may include a node device, such as devices operating within communication network described in reference to FIG. 1. In this example, computing device 400 includes at least one processor 491 communicably coupled to a computer-readable storage medium 492. The at least one processor 491 may include a microprocessor, a microcontroller, one or more central processing unit (CPU) cores, an application-specific integrated circuit (ASIC), one or more graphical processing unit (GPU) cores, a field programmable gate array (FPGA), and/or any other hardware device suitable for retrieval and execution of instructions from computer-readable storage medium 492. In instances, at least one processor 491 may include electronic circuitry for performing instructions described in this disclosure.

In instances, computer-readable storage medium 492 may be any medium suitable for storing executable instructions. In examples, without limitation, computer-readable storage medium 492 may include read-only memory (ROM), random-access memory (RAM), erasable electrically programmable ROM (EEPROM), Solid State Drive (SSD), optical disc, and the like. Computer-readable medium storage 492 may be disposed within computing device 400. In embodiments, computer-readable storage medium 492 may be external, and communicably connected, to computing device 400. The instruction stored on computer-readable storage medium may be used to implement method steps described in reference to FIG. 3.

In this example, computer-readable storage medium 492 is encoded with a set of instructions 493, 494 and 495. In embodiments, executable instructions included in each block may be included in different blocks shown and blocks not shown.

Instruction 493, when executed by at least one processor 491, configures the at least one processor 491 to determine an area of overlapping coverage of a first network node and a second network node based on an AoA for the first network node and an AoA for the second network node.

Instruction 494, when executed by at least one processor 491, configures the at least one processor 491 to determine a first set of PRBs for the first network node and a second set of PRBs for the second network node for the area of overlapping coverage.

Instruction 495, when executed by at least one processor 491, configures the at least one processor 491 to assign a PRB grouping to the first set of PRB that is different from a PRB grouping of the second set of PRB.

Instruction 496, when executed by at least one processor 491, configures the at least one processor 491 to assign a first network node segment and a second network node segment to the wireless device. In embodiments, the first network node segment and the second network node segment have the same AoA and the PRB grouping of the first grouping and the PRB grouping of the second grouping prevents overlapping of assigned PRB groups in specific angular separation.

In embodiments, computer-readable storage medium 492 may be encoded with instructions configuring the at least one processor 491 to determine angular coverage segments for the first network node and the second network node based on an AoA range of the first and second network nodes, wherein each angular coverage segment of the angular coverage segments comprises a subrange of the AoA range.

In embodiments, computer-readable storage medium may include instructions configuring the at least one processor 491 to assign the same AoA subrange to an angular coverage segment of the first network node and to an angular coverage segment of the second network node for the area of overlapping coverage.

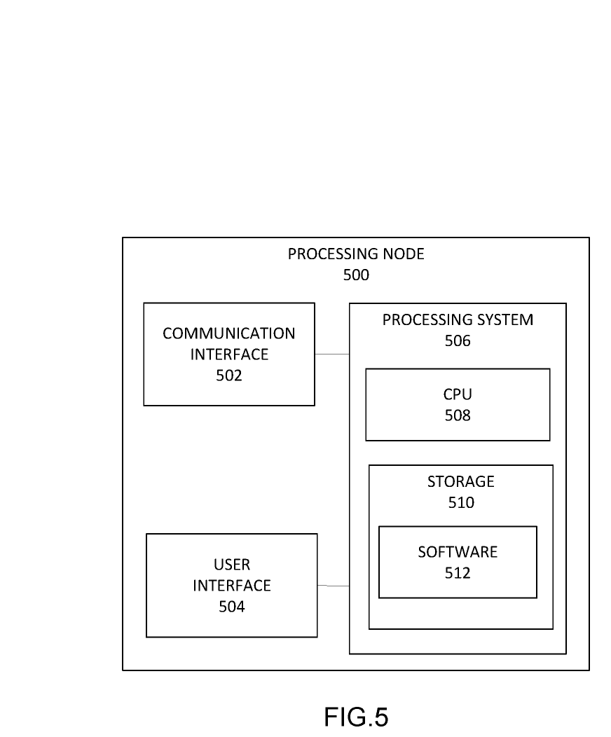

Now referring to FIG. 5, an example processing node 500, which may be configured to perform the methods and operations disclosed herein for network energy reduction. The processing node 500 includes a communication interface 502, user interface 504, and processing system 506 in communication with communication interface 502 and user interface 504. Communication interface 502 may include hardware components, such as network communication ports, devices, routers, wires, antenna, transceivers, etc. User interface 504 may include hardware components, such as touch screens, buttons, displays, speakers, etc.

Processing system 506 includes a central processing unit (CPU) or processor 508 and storage 510. Storage 510 may include a disk drive, flash drive, memory circuitry, or other memory device including, for example, a buffer. Storage 510 can store software 512 which is used in the operation of the processing node 500. Software 512 may include computer programs, firmware, or some other form of machine-readable instructions, including an operating system, utilities, drivers, network interfaces, applications, or some other type of software. Processing system 506 may include a processor 508 and other circuitry to retrieve and execute software 512 from storage 510, which may be internal or external to the processing system 506. Processing node 500 may further include other components such as a power management unit, a control interface unit, etc., which are omitted for clarity. Communication interface 502 permits processing node 500 to communicate with other network elements. User interface 504 permits the configuration and control of the operation of processing node 500. Processing node 500 may be included in various elements of the wireless network including a network node, proxy call session control function (P-CSCF), gateway mobile location center (GMLC), radio resource control (RRC), inter-cell interference coordination (ICIC), medium access control (MAC), session border controller (SBC), and the like. In this example, software 512 may include the instructions described in reference to FIG. 4.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all be within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, the method comprising:
determining an area of overlapping coverage of a first network node and a second network node based on an angle of arrival (AoA) for the first network node and an AoA for the second network node;
determining a first set of physical resource blocks (PRBs) for the first network node and a second set of PRBs for the second network node for the area of overlapping coverage; and
assigning a physical resource block (PRB) grouping to the first set of PRBs that is different from a PRB grouping of the second set of PRBs.

2. The method of claim 1, wherein the AoA for the first network node and the AoA for the second network node are the same AoA for the area of overlapping coverage.

3. The method of claim 1, further comprising determining angular coverage segments for the first network node and the second network node based on an AoA range of wireless devices of the first and second network, wherein each angular coverage segment of the angular coverage segments comprises a subrange of the AoA range.

4. The method of claim 3, further comprising assigning the same AoA subrange to an angular coverage segment of the first network node and to an angular coverage segment of the second network node for the area of overlapping coverage.

5. The method of claim 3, wherein assigning the PRB grouping to the first set of PRB comprises assigning the PRB grouping to an angular coverage segment of the first network node.

6. The method of claim 4, wherein assigning the PRB grouping to the second set of PRB comprises assigning the PRB grouping to an angular coverage segment of the second network node.

7. The method of claim 1, wherein assigning the PRB grouping to the first set of PRB and the PRB grouping to the second set of PRB comprises communicating the groupings using an inter-node interface.

8. The method of claim 7, wherein the inter-node interface is a Xn interface or a X2 interface.

9. The method of claim 1, wherein the AoA for the first and/or second network nodes are determined based on a time difference of arrival (TDOA) of at least one wireless device.

10. The method of claim 1, wherein the AoA for the first and/or second network nodes are determined based on a phase difference of arrival (PDOA) of at least one wireless device.

11. A system, the system comprising:
a wireless network comprising:
a first network node, a second network node and a computing device communicatively connected to the first and second network nodes, the computing device configured to:
determine an area of overlapping coverage of the first network node and the second network node based on an angle of arrival (AoA) for the first network node and an AoA for the second network node;
determine a first set of physical resource blocks (PRBs) for the first network node and a second set of PRBs for the second network node for the area of overlapping coverage; and
assign a physical resource block (PRB) grouping to the first set of PRBs that is different from a PRB grouping of the second set of PRBs.

12. The system of claim 11, wherein the AoA for the first network node and the AoA for the second network node are the same AoA for the area of overlapping coverage.

13. The system of claim 11, wherein the computing device is further configured to determine angular coverage segments for the first network node and the second network node based on an AoA range of wireless devices of the first and second network nodes, wherein each angular coverage segment of the angular coverage segments comprises a subrange of the AoA range.

14. The system of claim 13, wherein the computing device is configured to assign the same AoA subrange to an angular coverage segment of the first network node and to an angular coverage segment of the second network node for the area of overlapping coverage.

15. The system of claim 13, wherein assigning the PRB grouping to the first set of PRB comprises assigning the PRB grouping to an angular coverage segment of the first network node.

16. The system of claim 13, wherein assigning the PRB grouping to the second set of PRB comprises assigning the PRB grouping to an angular coverage segment of the second network node.

17. The system of claim 11, wherein assigning the PRB grouping to the first set of PRB and the PRB grouping to the second set of PRB comprises communicating the groupings using an inter-node interface.

18. The system of claim 17, wherein the inter-node interface is a Xn interface or a X2 interface.

19. A non-transitory computer-readable medium storing instructions, when executed by at least one processor, configuring the at least one processor to:
determine an area of overlapping coverage of a first network node and a second network node based on an angle of arrival (AoA) for the first network node and an AoA for the second network node;
determine a first set of physical resource blocks (PRBs) for the first network node and a second set of PRBs for the second network node for the area of overlapping coverage; and
assign a physical resource block (PRB) grouping to the first set of PRBs that are different from a PRB grouping of the second set of PRBs.

20. The non-transitory computer-readable medium storing instructions of claim 19, wherein the AoA for the first network node and the AoA for the second network node are the same AoA for the area of overlapping coverage.
